(19) United States
(12) Patent Application Publication
(10) Pub. No.: US 2021/0071398 A1
(43) Pub. Date: Mar. 11, 2021

(54) Countertop basin faucet with oral cleaner

(71) Applicant: RONG LAI LIU, Jiangmen (CN)

(72) Inventor: RONG LAI LIU, Jiangmen (CN)

(21) Appl. No.: 16/953,323

(22) Filed: Nov. 19, 2020

Related U.S. Application Data
(63) Continuation of application No. PCT/CN2018/085788, filed on May 7, 2018.

(30) Foreign Application Priority Data
Apr. 13, 2018 (CN) 201810333646X

(51) Int. Cl. E03C 1/04; F16K 11/20; A61C 17/02; A61C 17/032; A46B 11/06

(52) U.S. Cl. CPC E03C 1/0404; F16K 11/207; A46B 2200/1066; A61C 17/032; A46B 11/063; A61C 17/0202

(57) ABSTRACT

A countertop basin faucet with an oral cleaner includes a main body, a valve core, a pressing cover, a decorative cover and a handle. The main body includes a valve core cavity, a valve core seat at the bottom of the valve core cavity, a lower accommodating cavity, a water outlet pipe and a bubbler arranged at a water outlet end of the water outlet pipe. Also includes a seat sleeve communicated with the lower accommodating cavity, a water guide cavity disposed at an end of the valve core cavity adjacent to the valve core seat, a water diversion cavity communicated with the water guide cavity, a lower water outlet cavity and a faucet water outlet cavity communicated with the water outlet pipe, a water diversion switching core, a pressing cover, a pressure spring, a water diversion button, a lower water outlet pipe, a water guide hose, an oral cleaner.

### CROSS-REFERENCE TO RELATED APPLICATIONS

This application is a continuation of co-pending International Patent Application No. PCT/CN2018/085788 filed on May 7, 2018 which claims the priority and benefit of Chinese patent application number 201810333646.X, filed Apr. 13, 2018 with China National Intellectual Property Administration, the entire contents of which are incorporated herein by reference.

### TECHNICAL FIELD

The present disclosure belongs to the technical field of bathroom facilities, and particularly relates to a countertop basin faucet with a toothbrush, an oral irrigator and a tongue coating cleaner.

### BACKGROUND

A faucet, which is a popular name for a water valve, is used to control the velocity of water flow and starting and cutoff thereof, and has the effect of saving water. The faucet is one of the widely used bathroom products in people's daily life. There are many kinds of faucets, and the faucets can be divided into a spanner type, a lifting type, a pressing type, an induction type, etc. according to a turning on mode. A spanner type handle generally only needs to rotate by 90°; a lifting type handle only needs to lift up to let water out; a pressing type handle only needs to be pressed down to let water out and then released, and the faucet is automatically turned off with time delay; and an induction type faucet lets water out automatically only by putting a user's hand under the faucet. With the popularization of people's awareness of environmental protection, the concept of saving water is getting stronger, so faucets with better water-saving performance are increasingly welcomed in the market.

Based on the above, it is found that the existing faucets are only used for providing daily life water for washing, and the product structure and function are relatively simple, which cannot meet the requirements of brushing teeth, rinsing gums and slits between teeth, cleaning tongue coating, etc.; the existing oral irrigators cannot meet the demand for provision of living water, and are high in cost. Moreover, these oral irrigators need to be connected with a power supply before being used, which is easily subjected to potential electric leakage. The high heat generated by a motor during high-load use may also cause the generation of harmful substances to human body, and the noise during operation is very disturbing. In addition, the common oral irrigators cannot be connected with hot and cold water pipes, so water needs to be added manually. This not only makes the use process cumbersome, but also takes up limited bathroom space.

### SUMMARY

The objective of the present disclosure is to provide a countertop basin faucet with an oral cleaner, which can not only provide washing water, but also provide gargle water, and is convenient to switch and easy to use.

The present disclosure is implemented in this way: a countertop basin faucet with an oral cleaner, including a main body, a valve core, a pressing cover, a decorative cover and a handle, where the main body includes a valve core cavity, a valve core seat located at the bottom of the valve core cavity, a lower accommodating cavity, a water outlet pipe and a bubbler arranged at a water outlet end of the water outlet pipe; the valve core seat is provided with a cold water inlet hole and a hot water inlet hole; the valve core is arranged in the valve core cavity, the pressing cover is in threaded joint with the valve core cavity, the decorative cover is in threaded joint with the pressing cover, and the handle is connected to a valve rod of the valve core; where the main body also includes a seat sleeve communicated with the lower accommodating cavity, a water guide cavity disposed at an end of the valve core cavity adjacent to the valve core seat, a water diversion cavity communicated with the water guide cavity, a lower water outlet cavity and a faucet water outlet cavity communicated with the water outlet pipe; the top of the faucet water outlet cavity is provided with a cylindrical seat, and the cylindrical seat is provided with a water diversion switching core mounting hole and an internal thread portion from bottom to top;

a top plate of the water diversion cavity is provided with a top water diversion switching valve core hole, and a bottom plate is provided with a bottom water diversion switching valve core hole,

a bottom plate of the lower water outlet cavity is provided with a water outlet hole, and the water outlet hole is communicated with the lower accommodating cavity;

the main body also includes a water diversion switching core, a pressing cover, a pressure spring, a water diversion button, a lower water outlet pipe, a water guide hose and an oral cleaner,

a lower end of the water diversion switching valve core is in fitting and liquid sealing with the bottom water diversion switching valve core hole, a middle portion thereof is in liquid sealing with the top water diversion switching valve core hole, and the top thereof is in fitting and liquid sealing with the water diversion switching core mounting hole; a lower water outlet hole at a lower end of the water diversion switching core is communicated with the lower water outlet cavity, a faucet water outlet hole at an upper end thereof is communicated with the faucet water outlet cavity, and a water inlet hole at a middle portion thereof is communicated with the water diversion cavity; the pressing cover is in threaded joint with an internal thread of the cylindrical seat to fix the water diversion switching valve core, the water diversion button is in sliding fit with the cylindrical seat, the water diversion button is connected to the valve rod of the water diversion switching valve core, and the pressure spring is matched with the water diversion button and the pressing cover; the lower water outlet pipe is connected to the water outlet hole of the lower water outlet cavity, the other end of the lower water outlet pipe is connected to the water guide hose, and the other end of the water guide hose is connected to the oral cleaner; the oral cleaner is detachably matched with the seat sleeve, and the water guide hose is in sliding fit with the seat sleeve.

In the countertop basin faucet with an oral cleaner, the oral cleaner includes a cleaner main body and a toothbrush with a water nozzle, a tongue coating cleaner or an oral irrigator, and

the toothbrush with the water nozzle, the tongue coating cleaner or the oral irrigator is detachably matched with the cleaner main body.

In the countertop basin faucet with an oral cleaner, the cleaner main body is provided with a water stop switch.

In the countertop basin faucet with an oral cleaner, the toothbrush with the water nozzle includes a brush handle, a brush head with bristles, a water outlet nozzle arranged on the brush head and a water inlet channel disposed along the brush handle and the brush head and communicated with the water nozzle, and

the brush handle is provided with a flange and a port pipe, and the port pipe is detachably matched with a water outlet hole of the cleaner main body.

In the countertop basin faucet with an oral cleaner, a plurality of water outlet holes disposed at a round head, a water channel disposed along a handle portion and communicated with the round head, a flange and a port pipe are provided, and

the port pipe is detachably matched with the water outlet hole of the cleaner main body.

In the countertop basin faucet with an oral cleaner, the oral irrigator includes a pipe body portion, a water spray elbow arranged at a water outlet end of the pipe body portion, a flange disposed at a water inlet end of the pipe body portion and a port pipe, and

the port pipe is detachably matched with the water outlet hole of the cleaner main body.

In the countertop basin faucet with an oral cleaner, the seat sleeve and the valve core cavity are arranged left and right, and the water outlet pipe extends forward.

In the countertop basin faucet with an oral cleaner according to the present disclosure, through the arrangement of the water diversion switching valve core, the switching between washing water and gargle water can be implemented, and the countertop basin faucet is convenient to operate and low in use cost for consumers.

### BRIEF DESCRIPTION OF THE DRAWINGS

FIG. 1 is a cross-sectional view of the present disclosure;

FIG. 2a is a first cross-sectional view of a main body according to the present disclosure;

FIG. 2b is a second cross-sectional view of a main body according to the present disclosure;

FIG. 3 is a first stereoscopic cross-sectional view of the present disclosure;

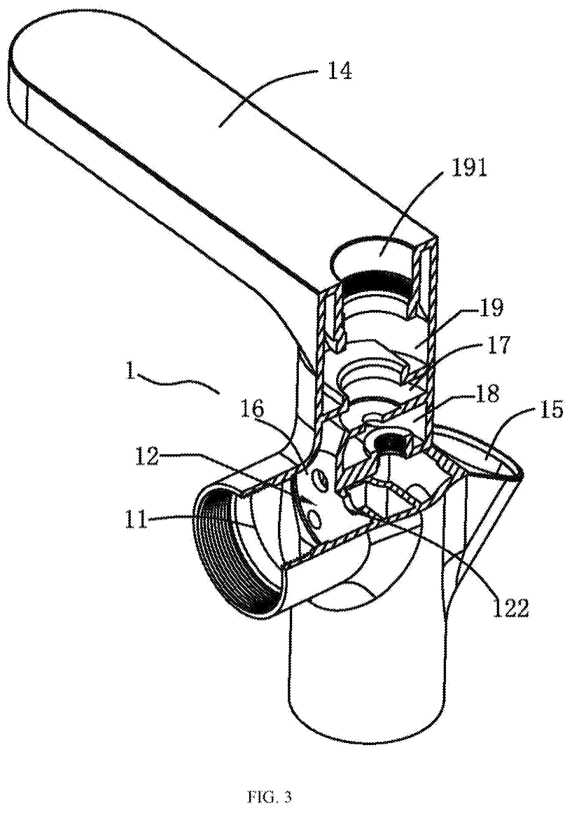

FIG. 4 is a second stereoscopic cross-sectional view of the present disclosure;

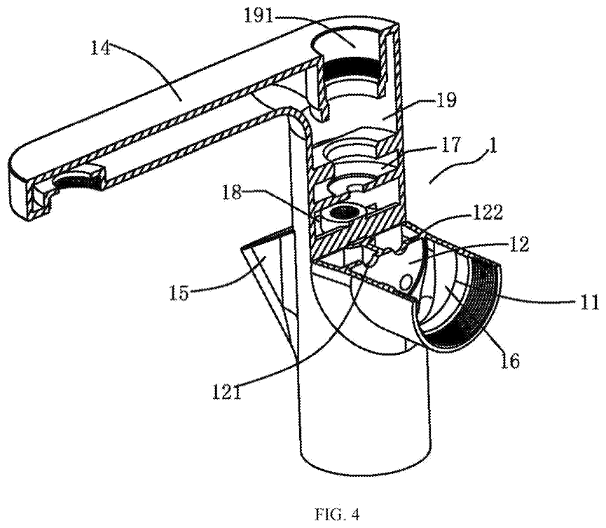

FIG. 5 is a first stereoscopic exploded view of the present disclosure;

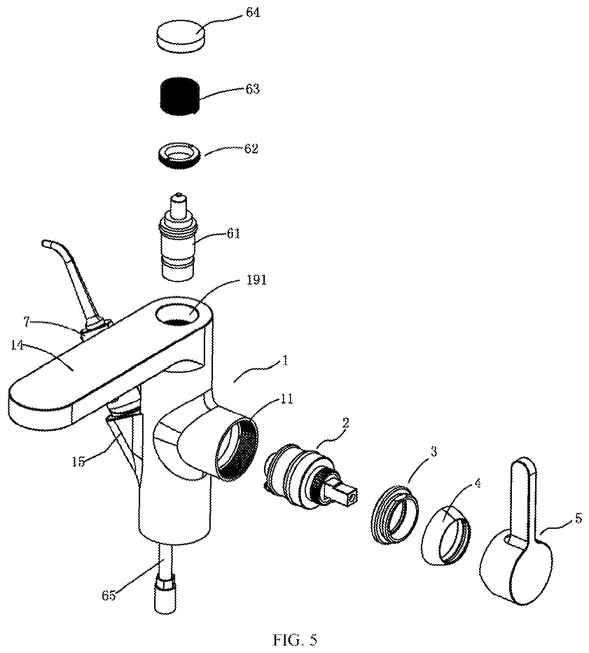

FIG. 6 is a second stereoscopic exploded view of the present disclosure;

FIG. 7 is a stereoscopic diagram of the present disclosure;

FIG. 8 is a stereoscopic diagram of a combination of a cleaner main body of an oral cleaner and a water guide hose according to the present disclosure;

FIG. 9 is a stereoscopic diagram of a toothbrush with a water nozzle according to the present disclosure;

FIG. 10 is a stereoscopic diagram of a tongue coating cleaner according to the present disclosure; and

FIG. 11 is a stereoscopic diagram of an oral irrigator according to the present disclosure.

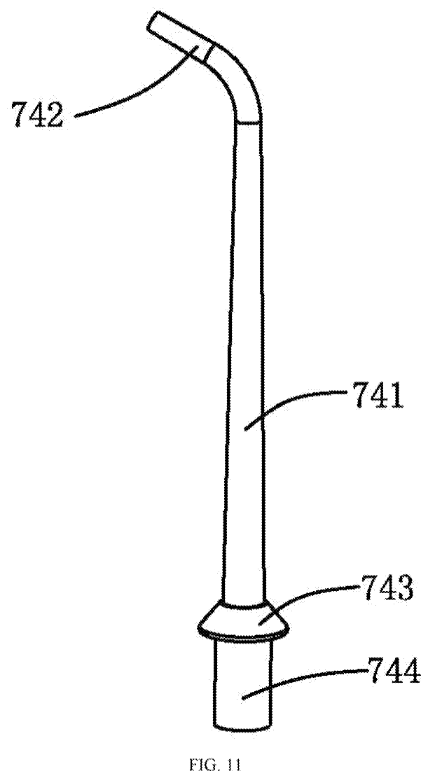

### DESCRIPTION OF THE EMBODIMENTS

The present disclosure is further described with reference to the accompanying drawings.

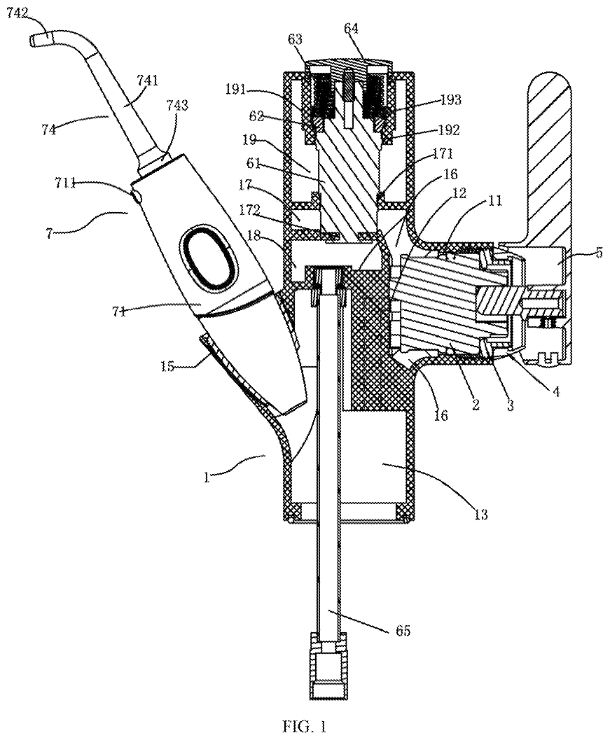

As shown in FIG. 1, a countertop basin faucet with an oral cleaner includes a main body 1, a valve core 2, a pressing cover 3, a decorative cover 4 and a handle 5, where the main body 1 includes a valve core cavity 11, a valve core seat 12 located at the bottom of the valve core cavity, a lower accommodating cavity 13, a water outlet pipe 14 and a bubbler 141 arranged at a water outlet end of the water outlet pipe; the valve core seat 12 is provided with a cold water inlet hole 121 and a hot water inlet hole 122; the valve core 2 is arranged in the valve core cavity 11, the pressing cover 3 is in threaded joint with the valve core cavity 11, the decorative cover 4 is in threaded joint with the pressing cover 3, and the handle 5 is connected to a valve rod of the valve core 2.

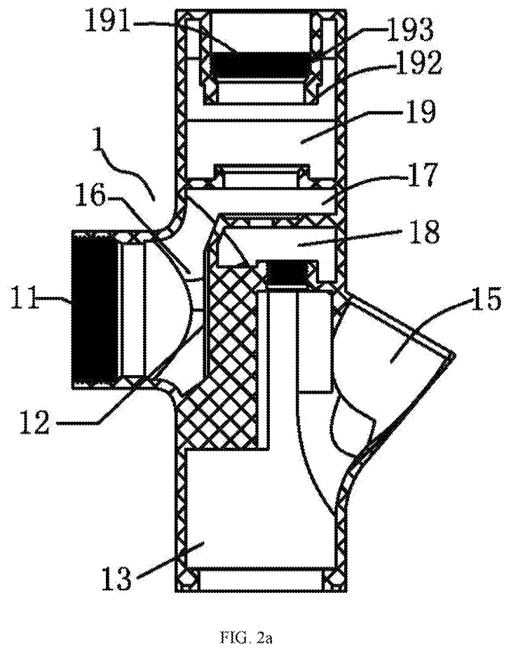

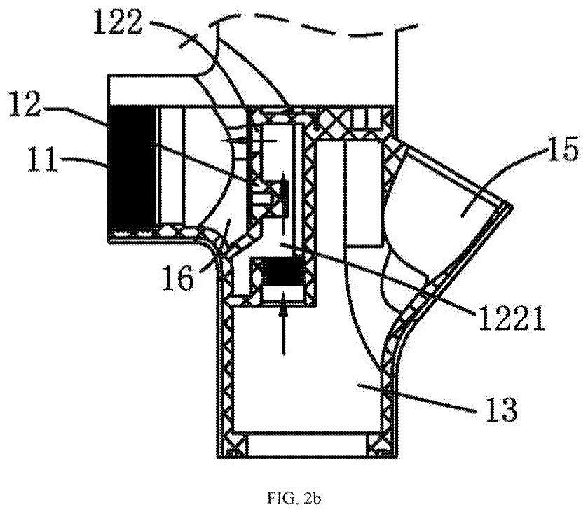

As shown in FIG. 2b, the axis of the hot water inlet hole 122 is parallel to the horizontal plane, and the main body also includes a vertical water guide channel 1221. The hot water inlet hole 122 is communicated with the vertical water guide channel 1221, and a water inlet end of the vertical water guide channel 1221 is located in the lower accommodating cavity 13.

the main body 1 also includes a seat sleeve 15 communicated with the lower accommodating cavity, a water guide cavity 16 disposed at an end of the valve core cavity 11 adjacent to the valve core seat 12, a water diversion cavity 17 communicated with the water guide cavity 16, a lower water outlet cavity 18 and a faucet water outlet cavity 19 communicated with the water outlet pipe; the top of the faucet water outlet cavity 19 is provided with a cylindrical seat 191, and the cylindrical seat 191 is provided with a water diversion switching core mounting hole 192 and an internal thread portion 193 from bottom to top;

a top plate of the water diversion cavity 17 is provided with a top water diversion switching valve core hole 171, a bottom plate is provided with a bottom water diversion switching valve core hole 172, the top water diversion switching valve core hole 171 is communicated with the faucet water outlet cavity 19, and the bottom water diversion switching valve core hole 172 is communicated with the lower water outlet cavity 18;

a bottom plate of the lower water outlet cavity 18 is provided with a water outlet hole, and the water outlet hole is communicated with the lower accommodating cavity 13;

the main body also includes a water diversion switching core 61, a pressing cover 62, a pressure spring 63, a water diversion button 64, a lower water outlet pipe 65, a water guide hose 66 and an oral cleaner 7,

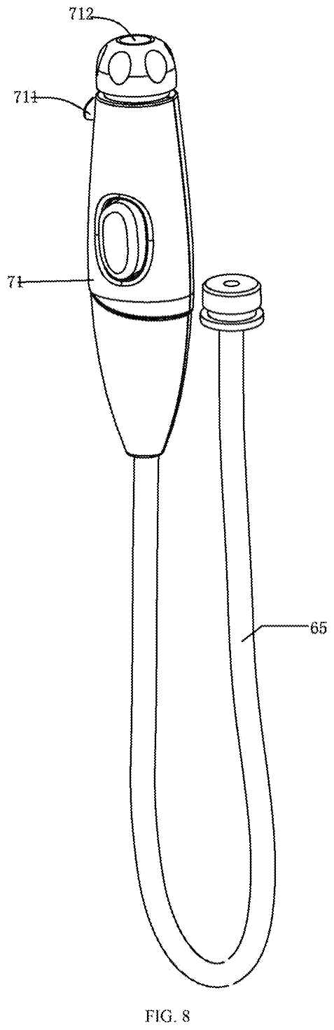

a lower end of the water diversion switching valve core 61 is in fitting and liquid sealing with the bottom water diversion switching valve core hole 172, a middle portion thereof is in liquid sealing with the top water diversion switching valve core hole 171, and the top thereof is in fitting and liquid sealing with the water diversion switching core mounting hole 192; a lower water outlet hole at a lower end of the water diversion switching core 61 is communicated with the lower water outlet cavity 18, a faucet water outlet hole at an upper end thereof is communicated with the faucet water outlet cavity 19, and a water inlet hole at a middle portion thereof is communicated with the water diversion cavity 17; the pressing cover 62 is in threaded joint with an internal thread 193 of the cylindrical seat 191 to fix the water diversion switching valve core 61, the water diversion button 64 is in sliding fit with the cylindrical seat 191, the water diversion button 64 is connected to the valve rod of the water diversion switching valve core 61, and the pressure spring 63 is matched with the water diversion button 64 and the pressing cover 62; as shown in FIG. 8, the lower water outlet pipe 65 is connected to the water outlet hole of the lower water outlet cavity 18, the other end of the lower water outlet pipe 65 is connected to the water guide hose, and the other end of the water guide hose is connected to the oral cleaner 7; the oral cleaner 7 is detachably matched with the seat sleeve 15, and the water guide hose is in sliding fit with the seat sleeve 15.

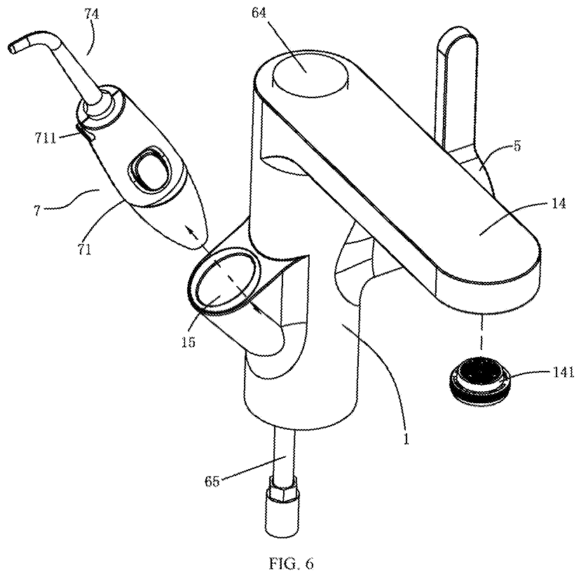

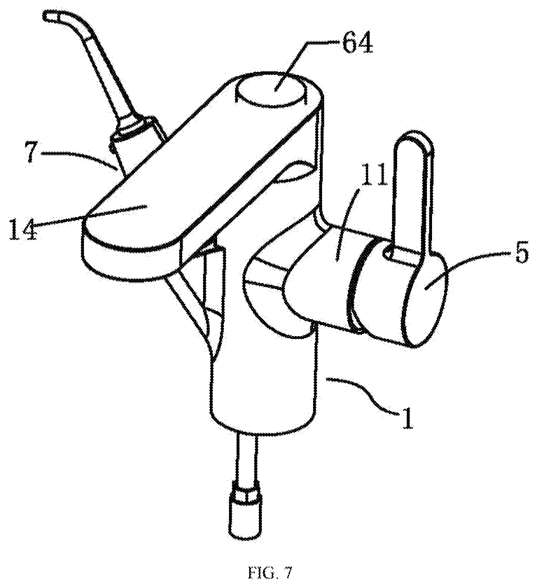

As shown in FIGS. 6 and 7, the seat sleeve and the valve core cavity are arranged left and right, and the water outlet pipe extends forward.

The oral cleaner 7 includes a cleaner main body 71 and a toothbrush 72 with a water nozzle, a tongue coating cleaner 73 or an oral irrigator 74, and

the toothbrush 72 with the water nozzle, the tongue coating cleaner 73 or the oral irrigator 74 is detachably matched with the cleaner main body 71; and

the cleaner main body 71 is provided with a water stop switch.

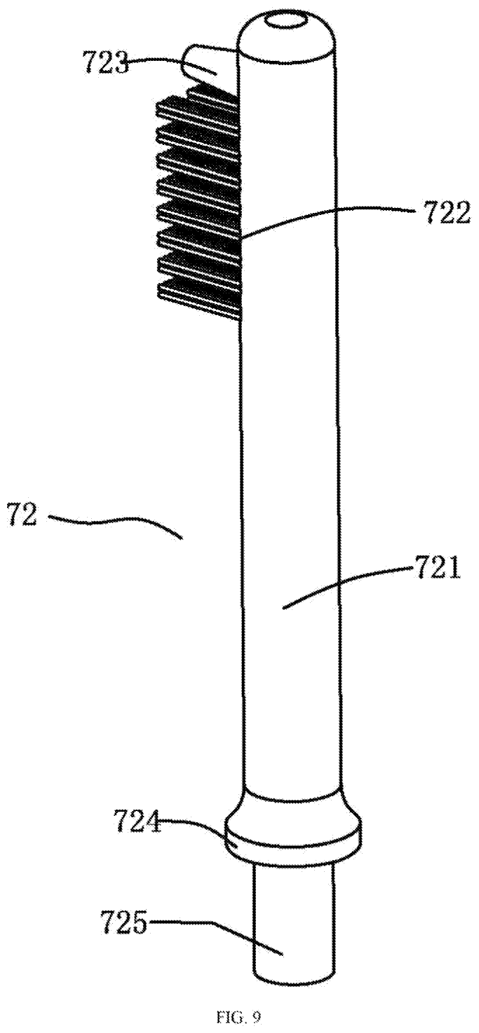

As shown in FIG. 9, the toothbrush 72 with the water nozzle includes a brush handle 721, a brush head 722 with bristles, a water outlet nozzle 723 arranged on the brush head and a water inlet channel disposed along the brush handle and the brush head and communicated with the water nozzle, and

the brush handle 721 is provided with a flange 724 and a port pipe 725, and the port pipe 725 is detachably matched with a water outlet hole of the cleaner main body 71. The flange 724 is matched with the cleaner main body 71 for stopping.

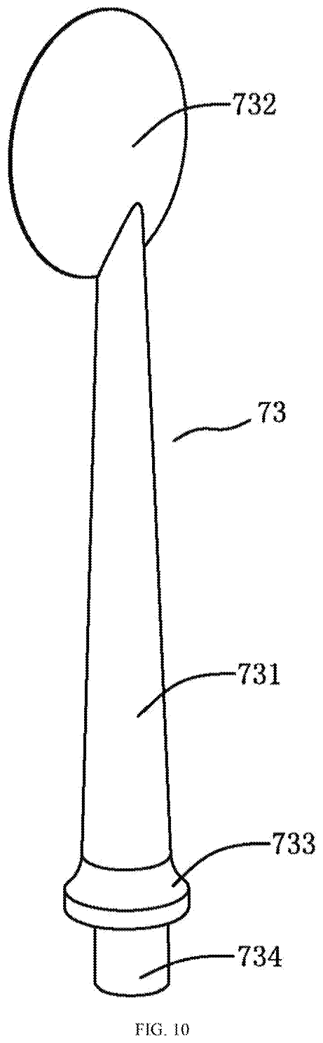

As shown in FIG. 10, the tongue coating cleaner 73 includes a handle portion 731, a hollow round head 732 with bristles, a plurality of water outlet holes (not shown in the figure) disposed at the round head, a water channel disposed along the handle portion and communicated with the round head, a flange 733 and a port pipe 734,

the port pipe 734 is detachably matched with a water outlet hole 712 of the cleaner main body 71, and the flange 733 is matched with the cleaner main body 71 for stopping.

The oral irrigator 74 includes a pipe body portion 741, a water spray elbow 742 arranged at a water outlet end of the pipe body portion, a flange 743 disposed at a water inlet end of the pipe body portion and a port pipe 744, and

the port pipe is detachably matched with the water outlet hole 712 of the cleaner main body.

When the present disclosure is used, the handle 5 is rotated, and cold water, hot water or mixed cold and hot water enter the water guide cavity 16; the water diversion switching valve core 61 is in a normal state, and the water diversion switching valve core 61 communicates the water diversion cavity 17 with the faucet water outlet cavity 19, which is called a washing state. When switching is needed, the water diversion button 64 is pressed, and the water diversion switching valve core 61 communicates the water diversion cavity 17 with the lower water outlet cavity 18. Under the action of the pressure spring 63, the water diversion button is reset, which is called a gargle state; and the water diversion button 64 is pressed again, so that the water diversion switching valve core 61 returns to a normal state.

In the washing state, the handle 5 is operated, so that face washing water or clothes washing water flows out of the water outlet pipe 14 on the main body 1;

in the gargle state, when the handle 5 is operated, water enters the lower water outlet cavity 18, the lower water outlet pipe 65 and the water guide hose 65 through the water diversion cavity 17 and the water diversion switching valve core 61 and enters the cleaner main body 71; the oral cleaner 7 is separated from the seat sleeve 15, and the water guide hose 95 extends out of the seat sleeve 15; and the water stop switch 711 is operated, so that water enters the toothbrush 72 with the water nozzle, the tongue coating cleaner 73 or the oral irrigator 74.

The above are only the preferred embodiments of the present disclosure. It should be pointed out that for a person of ordinary skilled in the art, several improvements and variations may also be made without departing from the principle of the present disclosure, and these improvements and variations should also be considered as falling within the protection scope of the present disclosure.

What is claimed is:

1. A countertop basin faucet with an oral cleaner, comprising a main body, a valve core, a pressing cover, a decorative cover and a handle, wherein the main body comprises a valve core cavity, a valve core seat located at the bottom of the valve core cavity, a lower accommodating cavity, a water outlet pipe and a bubbler arranged at a water outlet end of the water outlet pipe; the valve core seat is provided with a cold water inlet hole and a hot water inlet hole; the valve core is arranged in the valve core cavity, the pressing cover is in threaded joint with the valve core cavity, the decorative cover is in threaded joint with the pressing cover, and the handle is connected to a valve rod of the valve core; wherein the main body also comprises a seat sleeve communicated with the lower accommodating cavity, a water guide cavity disposed at an end of the valve core cavity adjacent to the valve core seat, a water diversion cavity communicated with the water guide cavity, a lower water outlet cavity and a faucet water outlet cavity communicated with the water outlet pipe; the top of the faucet water outlet cavity is provided with a cylindrical seat, and the cylindrical seat is provided with a water diversion switching core mounting hole and an internal thread portion from bottom to top; the water outlet pipe is perpendicular to the faucet water outlet cavity; the water outlet pipe, the faucet water outlet cavity and the top of the faucet water outlet cavity are integrally formed by the cylindrical seat are integral forming;
a top plate of the water diversion cavity is provided with a top water diversion switching valve core hole, and a bottom plate is provided with a bottom water diversion switching valve core hole,
a bottom plate of the lower water outlet cavity is provided with a water outlet hole, and the water outlet hole is communicated with the lower accommodating cavity;
the main body also comprises a water diversion switching core, a pressing cover, a pressure spring, a water diversion button, a lower water outlet pipe, a water guide hose and an oral cleaner,
a lower end of the water diversion switching valve core is in fitting and liquid sealing with the bottom water diversion switching valve core hole, a middle portion thereof is in liquid sealing with the top water diversion switching valve core hole, and the top thereof is in fitting and liquid sealing with the water diversion switching core mounting hole; a lower water outlet hole at a lower end of the water diversion switching core is communicated with the lower water outlet cavity, a faucet water outlet hole at an upper end thereof is communicated with the faucet water outlet cavity, and a water inlet hole at a middle portion thereof is communicated with the water diversion cavity; the pressing cover is in threaded joint with an internal thread of the cylindrical seat to fix the water diversion switching valve core, the water diversion button is in sliding fit with the cylindrical seat, the water diversion button is connected to the valve rod of the water diversion switching valve core, and the pressure spring is matched with the water diversion button and the pressing cover; the lower water outlet pipe is connected to the water outlet hole of the lower water outlet cavity, the other end of the lower water outlet pipe is connected to the water guide hose, and the other end of the water guide hose is connected to the oral cleaner; the oral cleaner is detachably matched with the seat sleeve, and the water guide hose is in sliding fit with the seat sleeve.

2. The countertop basin faucet with an oral cleaner as recited in claim 1, wherein the oral cleaner comprises a cleaner main body and a toothbrush with a water nozzle, a tongue coating cleaner or an oral irrigator, and
the toothbrush with the water nozzle, the tongue coating cleaner or the oral irrigator is detachably matched with the cleaner main body.

3. The countertop basin faucet with an oral cleaner as recited in claim 2, wherein the cleaner main body is provided with a water stop switch.

4. The countertop basin faucet with an oral cleaner as recited in claim 2, wherein the toothbrush with the water nozzle comprises a brush handle, a brush head with bristles, a water outlet nozzle arranged on the brush head and a water inlet channel disposed along the brush handle and the brush head and communicated with the water nozzle, and
the brush handle is provided with a flange and a port pipe, and the port pipe is detachably matched with a water outlet hole of the cleaner main body.

5. The countertop basin faucet with an oral cleaner as recited in claim 3, wherein the toothbrush with the water nozzle comprises a brush handle, a brush head with bristles, a water outlet nozzle arranged on the brush head and a water inlet channel disposed along the brush handle and the brush head and communicated with the water nozzle, and
the brush handle is provided with a flange and a port pipe, and the port pipe is detachably matched with a water outlet hole of the cleaner main body.

6. The countertop basin faucet with an oral cleaner as recited in claim 2, wherein a plurality of water outlet holes disposed at a round head, a water channel disposed along a handle portion and communicated with the round head, a flange and a port pipe are provided, and
the port pipe is detachably matched with the water outlet hole of the cleaner main body.

7. The countertop basin faucet with an oral cleaner as recited in claim 3, wherein a plurality of water outlet holes disposed at a round head, a water channel disposed along a handle portion and communicated with the round head, a flange and a port pipe are provided, and
the port pipe is detachably matched with the water outlet hole of the cleaner main body.

8. The countertop basin faucet with an oral cleaner as recited in claim 2, wherein the oral irrigator comprises a pipe body portion, a water spray elbow arranged at a water outlet end of the pipe body portion, a flange disposed at a water inlet end of the pipe body portion and a port pipe, and
the port pipe is detachably matched with the water outlet hole of the cleaner main body.

9. The countertop basin faucet with an oral cleaner as recited in claim 3, wherein the oral irrigator comprises a pipe body portion, a water spray elbow arranged at a water outlet end of the pipe body portion, a flange disposed at a water inlet end of the pipe body portion and a port pipe, and
the port pipe is detachably matched with the water outlet hole of the cleaner main body.

10. The countertop basin faucet with an oral cleaner as recited in claim 1, wherein the seat sleeve and the valve core cavity are arranged left and right, and the water outlet pipe extends forward.
